(19) United States
(12) Patent Application Publication
(10) Pub. No.: US 2019/0170057 A1
(43) Pub. Date: Jun. 6, 2019

(54) CHARGE AIR COOLER (CAC) HAVING A CONDENSATE DISPERSION DEVICE AND A METHOD OF DISPERSING CONDENSATE FROM A CAC

(71) Applicant: GM Global Technology Operations LLC, Detroit, MI (US)

(72) Inventor: James A. Lasecki, Farmington Hills, MI (US)

(21) Appl. No.: 15/833,333

(22) Filed: Dec. 6, 2017

(51) Int. Cl. F02B 29/04

(52) U.S. Cl. CPC F02B 29/0468

(57) ABSTRACT

A charge air cooler (CAC) having a condensate dispersion device and method of using the same is provide. The CAC includes an outlet housing having an outlet port. The outlet housing includes a condensate receiver located at a lower portion of the outlet housing. A plurality of airflow tubes is in fluid communication with the outlet housing and a portion of a wicking material partially disposed in the outlet housing. A first end of the wicking material is disposed in the condensate receiver and a second end of the wicking tube extends out of the outlet housing through the outlet port, preferably into an outlet duct toward an intake manifold of an internal combustion engine.

### INTRODUCTION

The present disclosure relates to a vehicle heat exchanger, more particularly to a charge air cooler.

Modern high efficiency engines utilizes compressors, such as supercharges and turbocharges, to increase the power of an internal combustion engines during periods of high output power demands, such as accelerating from a stop light or margining onto a highway. The compressors increase the density of air, enabling the combustion process to burn more fuel per cycle, thus increasing power output.

The temperature of the compressed air is significantly higher than the ambient inlet air due to the compression process. Charge-air coolers (CAC) are employed to remove excessive heat from the compressed air prior to the inlet of the combustion chamber of the internal combustion engine to enhance combustion efficiency, resulting in improved fuel economy and fewer undesirable emissions. CAC are typically air-to-air heat exchangers where heat from the higher temperature compressed combustion air flowing through the CAC is transferred to the external cooler ambient air, resulting in a reduction in temperature of the combustion air.

During periods of low power demand, such as idling or normal cruising conditions, when the intake air is not as highly compressed as when there is a high power demand, the effectiveness of the CAC can cause the internal airflow through the CAC to experience a transition in temperature to fall below the dew point temperature, thereby causing moisture in the intake air to condense forming water condensate within the CAC. A sufficient volume of condensate may accumulate within the CAC, thereby obstructing air flow through the CAC to the engine. As the pressure, temperature, and flow rate of combustion air through the CAC are increased due to high output demands, sufficient amounts of condensate may be evaporated and/or droplets of condensate may be dislodged into the combustion air flow. Unmetered water vapor and condensate droplets entering the combustion chamber of the engine may hinder the combustion process, thus resulting in undesirable engine performance. Furthermore, depending on the external ambient air temperature, the accumulated condensate within the CAC may freeze, thereby further obstructing combustion airflow through the CAC as well as potentially damaging the CAC.

Thus, while current CAC achieve their intended purpose, there is a need for a CAC having a new and improved condensate dispersion device, and a method for dispersing condensate from CAC.

### SUMMARY

According to several aspects, a heat exchanger having a condensate dispersion device is disclosed. The heat exchanger includes an outlet housing having an interior surface defining an outlet airflow chamber, and an outlet port in fluid communication with the outlet airflow chamber; an outlet duct in fluid having an interior surface defining an outlet duct airflow passageway in fluid communication with the outlet port; and a wicking material having a first end and a second end opposite the first end. The first end is disposed in the outlet airflow chamber and the second end is disposed in the outlet duct airflow passageway.

In an additional aspect of the present disclosure, the interior surface of the outlet housing further defines a condensate receiver located at a lower portion of the outlet airflow chamber and the first end of the wicking material is disposed within the condensate receiver.

In another aspect of the present disclosure, the wicking material includes an elongated body extending from the first end through the outlet port to the second end.

In another aspect of the present disclosure, the heat exchanger further includes an airflow tube having an airflow tube outlet end in fluid communication with the outlet airflow chamber. A first portion of the elongated body of the wicking material is spaced from the airflow tube outlet end and abuts against a portion of the interior surface of the outlet housing such that the wicking material does not substantially obstruct an airflow through the outlet airflow chamber

In another aspect of the present disclosure, a second portion of the elongated body of the wicking material is abutted against a portion of the interior surface of the outlet duct such that the wicking material does not substantially obstruct the airflow through the outlet duct airflow passageway

In another aspect of the present disclosure, the heat exchanger further includes a plurality of fasteners fixing the first and second portions of the elongated body of the wicking material against the portion of the interior surface of the outlet housing and against the portion of the interior surface of the outlet duct, respectively.

In another aspect of the present disclosure, the wicking material comprises a rectangular cross-section.

In another aspect of the present disclosure, the wicking material includes a material configured to draw condensate and releases the drawn condensate into a stream of airflow by evaporation.

In another aspect of the present disclosure, the first end of the wicking material includes a first cross-sectional area and the elongated body includes a second cross-sectional area, in which the first cross-sectional area is greater than the second cross sectional area.

According to several aspects, a charge air cooler having a condensate dispersion device is disclosed. The CAC includes an inlet housing having an inlet port configured to receive a heated pressurized airflow containing a water vapor; an outlet housing having an outlet port and an interior surface defining a condensate receiver located at a lower portion of the outlet housing; a plurality of airflow tubes connecting the inlet housing to the outlet housing such that the inlet housing is in fluid communication with the outlet housing, in which the plurality of airflow tubes are configured transfer heat from the heated pressurized airflow to an ambient airflow; and a wicking material partially disposed in the condensate receiver and extending through the outlet port of the outlet housing.

In an additional aspect of the present disclosure, the CAC further includes an outlet duct having an inlet end engaged to the outlet port of the outlet housing and an outlet end opposite of the inlet end. The wicking material includes a first end, a second end opposite the first end, and an elongated body extending from the first end to the second end. The first end of the wicking material is disposed within the condensate receiver, the second end of the wicking material is disposed within the outlet duct, and the elongated body extends from the outlet housing into the outlet duct through the outlet port.

In another aspect of the present disclosure, the elongated body of the wicking material is abutted against a portion of the interior surface of the outlet housing and against a portion of an interior surface of the outlet duct such that the wicking material does not substantially obstruct the airflow through the outlet housing and outlet duct.

In another aspect of the present disclosure, the CAC further includes a plurality of fasteners fixing the elongated body of the wicking material against the respective portions of the interior surfaces of the outlet housing and of the outlet duct.

In another aspect of the present disclosure, the wicking material includes a rectangular cross-section.

In another aspect of the present disclosure, the wicking material includes a material configured to draw condensate from the condensate receiver and evaporate the drawn condensate into a stream of airflow through the outlet duct.

In another aspect of the present disclosure, the wicking material includes a braided strand material.

According to several aspects, a method of dispersing condensate from a charge air cooler is disclosed. The method includes the steps of cooling an airflow containing moisture below a dew point of the airflow such that a portion of the moisture condenses into droplets of liquid; passing the airflow through an outlet housing of the charge air cooler such that a portion of the droplets coalesces into a condensate and settles into a lower portion of the outlet housing; wetting a wicking material by contacting a first portion of the wicking material with the settled condensate such that the condensate wets a second portion of the wicking material extending from the first portion; and exposing the second portion of the wicking material to the airflow such that the condensate wetting the second portion evaporates into the airflow.

In an additional aspect of the present disclosure, the method further includes the step of fixing the second portion of the wicking material against an internal surface of the outlet housing such that the second portion of the wicking material does not substantially obstruct the airflow through the outlet housing.

In another aspect of the present disclosure, the method further includes the step of extending the second portion of the wicking material through an outlet port of the outlet housing into an outlet duct.

In another aspect of the present disclosure, the method further includes the steps collecting the settled condensate in a condensate receiver located at a lower portion of the outlet housing; and disposing the first portion of the wicking material in the condensate receiver such that the first portion of the wicking material is contact with the condensate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows an air intake system, having a charge air cooler (CAC), for an internal combustion engine, according to an exemplary embodiment;

FIG. 2 shows a condensate wick disposed within an end housing of the CAC of FIG. 1, according to an exemplary embodiment;

FIG. 3A shows the condensate wick of FIG. 2, according to an exemplary embodiment; and

FIG. 3B shows the condensate wick of FIG. 2, according to another exemplary embodiment.

### DETAILED DESCRIPTION

The following description is merely exemplary in nature and is not intended to limit the present disclosure, application, or uses. It should be understood that throughout the drawings, corresponding reference numerals indicate like or corresponding parts and features.

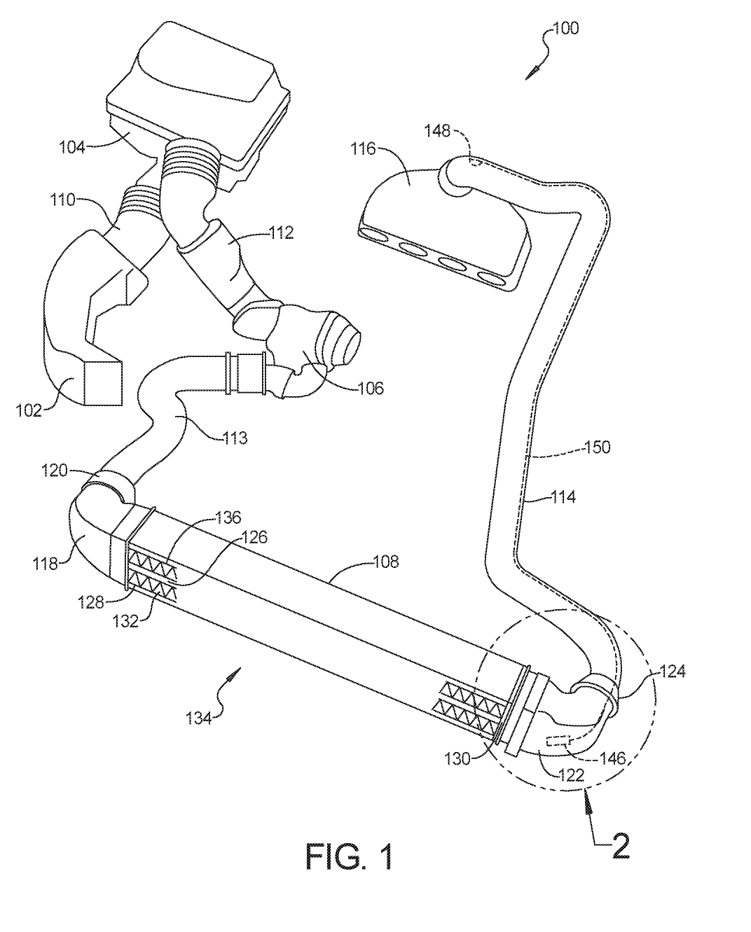

FIG. 1 shows an intake system 100 for delivering combustion air to an internal combustion engine (not shown). The combustion air is mixed with fuel to form an ignitable air/fuel mixture for a combustion process in the engine to generate power to propel a vehicle, such as an on-road vehicle, water vehicle, or air vehicle. The internal combustion engine may also be used as a power generating component on a hybrid vehicle to charge an electrical system or to assist in propelling the hybrid vehicle.

The intake system 100 includes an ambient air inlet 102, an air filter assembly 104, an air compressor 106, and a charge air cooler (CAC) 108. Ambient air is collected through the ambient air inlet 102 and conveyed to the air filter assembly 104 through an air intake duct 110. The air filter assembly 104 contains a filter media (not shown) that removes particular matter from the airflow that may damage the intake system 100 and/or the engine. The filtered airflow exits the air filter assembly 104 and is directed to the compressor 106 through a compressor inlet duct 112. The compressor 106 selectively compresses the volume of airflow, thereby increasing the pressure and temperature of the airflow above the pressure and temperature of the ambient air.

The compressed airflow exiting the compressor 106 is routed through a CAC inlet duct 113 to the CAC 108. Heat is removed from the compressed airflow by the CAC 108 to reduce the temperature of the compressed airflow. The cooled compressed air flow exits the CAC 108 through the CAC outlet duct 114 to the engine intake manifold 116 and to the engine combustion chambers (not shown). Fuel may be introduced into the cooled compressed airflow immediately prior to the combustion chambers or within the combustion chambers.

The compressor 106 compresses the volume of filtered air flow to increase the density of the airflow, thereby providing more oxygen per unit volume of airflow to the engine for more efficient combustion of fuel to increased power output. The compressor 106 may be that of a supercharger or a turbocharger type compressor. Supercharger type compressors are typically powered by a mechanical power-takeoff, such as a belt, gear, and/or shaft, from a crankshaft of the engine. Modern supercharger type compressors are powered by an electrical motor to avoid direct power draw from the engine. Turbocharger type compressors are powered by the hot exhaust gases of the engine, in which the hot exhaust gases turn a turbine that compresses the filtered airflow.

The compressors 106 selectively increase the density of the combustion airflow depending on the demand for output power from the engine. The greater the density of the combustion air supplied to the engine, the greater the output power that the engine can generate. Also, the greater the density, the greater amount of heat is generated during the compression process. Turbocharger type compressors generate greater amounts of heat than supercharger type compressors due to the heat transferred from the hot exhaust gases conducted through the metallic housing and turbine of the turbocharger type compressor to the airflow that is being compressed. Exemplary temperatures of the compressed airflow exiting a turbocharger type compressor can be as high as 200° C.

The compressed airflow exiting the compressor 106 is routed through the CAC 108 to reduce the temperature of the compressed airflow before being routed to the engine. The exemplary CAC 108 includes an inlet housing 118 having an air inlet port 120 and an air outlet housing 122 having an air outlet port 124. A plurality airflow tubes 126 fluidically connect the inlet housing 118 to the outlet housing 122. At least one of the plurality of tubes 126 include an inlet end 128 in fluid connection with the inlet housing 118 and an opposite outlet end 130 in fluid connection with the outlet housing 122. The plurality of airflow tubes 126 extends parallel with each other from the inlet housing 118 to the outlet housing 122.

The CAC 108 also includes a plurality of corrugated fins 132 interconnecting the external surfaces of adjacent fluid tubes 126 to increase the external surface area of the CAC 108 for increased heat transfer efficiency. The plurality of airflow tubes 126 and the plurality of corrugated fins 132 defines a CAC core 134 sandwiched between the inlet housing 118 and outlet housing 122. The corrugated fins 132 interconnecting adjacent airflow tubes 126 defines a plurality of external airflow passageways 136. The airflow passageways 136 provides for ambient airflow through the core 134 perpendicular to the compressed airflow through the airflow tubes 126. While a corrugated type fin is shown, it should be appreciated that other types of air-side fins 132, such as plate fins, may be utilized to increase the external heat transfer area of the CAC 108.

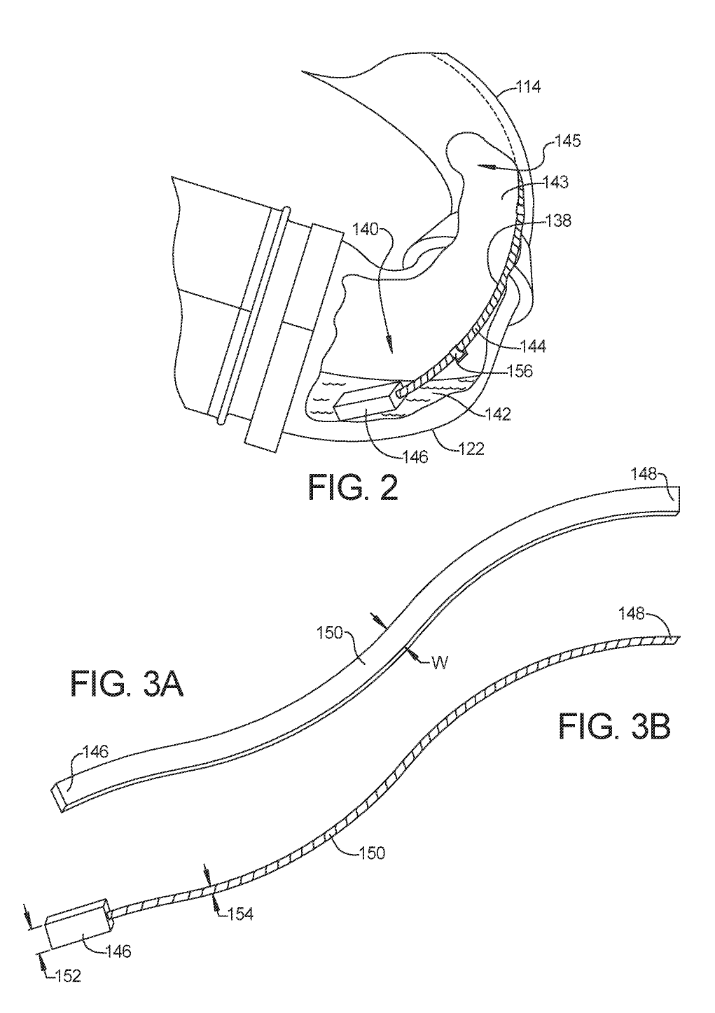

FIG. 2 shows a partial cut-away view of the outlet housing 122 of the CAC 108 and an outlet duct 114 extending from the outlet housing 122, as generally indicated with reference numeral 2 in FIG. 1. The outlet housing 122 includes an interior surface 138 defining an outlet airflow chamber, generally indicated with reference number 140, having a condensate receiver 142. The outlet duct 114 includes an interior surface 143 defining an outlet duct airflow passageway 145. It is preferable that the condensate receiver 142 is located at a lower portion of the outlet airflow chamber 140 where liquid condensate would settle under the force of gravity. A condensate wicking material 144 is shown partially disposed within the outlet airflow chamber 140 of the CAC 108 and extending into the CAC outlet duct 114 toward the engine intake manifold 116. A first portion of the wicking material 144 is located within the outlet housing 122 and a second portion is located within the outlet duct 114. A segment of the first portion of the wicking material 144 is disposed within the lower portion of the chamber 140 such that any condensate settled within the condensate receiver would come in physical contact with the wicking material 144.

Shown in FIG. 3A and FIG. 3B are exemplary condensate wicking material 144 having a first end 146, a second end 148 opposite of the first end 146, and an elongated body 150 extending therebetween. The condensate wicking material 144 may be any material that is capable of drawing, or wicking, condensate and allowing the wicked condensate to evaporate into an airflow upon contact with the airflow. Examples of wicking materials includes, but are not limited to, hydrophilic materials, absorbent materials such as sponges, adsorbent materials such as activated carbon, and materials having multiple strands capable of inducing capillary action.

In the embodiment shown in FIG. 3B, the first end 146 of the wicking material 144 includes a first cross-sectional area 152 and the elongated body 150 includes a second cross-sectional area 154. The first cross-sectional 152 area is larger than the cross-sectional area 154 of the elongated body 150. The larger cross sectional area of the first end 146 provides greater contact area with the condensate settled within the condensate receiver 142. The first end 146 may include a first wicking material and the elongated body 150 may include a second wicking material. In one embodiment, the first and second wicking material are the same material. In another embodiment, the first and second wicking material are different materials.

The elongated body 150 may be abutted against the interior surface 138 of the outlet housing 122 and fixed in position with adhesives or fasteners 156 to prevent the wicking material 144 from significantly obstructing airflow through the outlet housing 122 such that the combustion process is undesirably affected. The wicking material 144 may include any shaped cross-sectional area including a rectangle as shown in FIG. 3A, a circle as shown in FIG. 3B, or square. An advantage of a rectangular cross-sectional wicking material 144 is that the wider width W of the wicking material 144 may be fixed on the interior surfaces of the outlet housing 122 and/or outlet duct 114 to minimize the protrusion of the wicking material 144 into the airflow, thereby minimizing any disturbance of airflow to the engine.

The CAC core 134 is configured to provide sufficient cooling of the high temperature compressed airflow from the compressor 106 during periods of high power output demand from engine. However, during periods of nominal or low power output demand from the engine, the compressor 106 is not compressing the combustion air to a pressure and temperature as high as during periods of high power output demand. As the lower temperature compressed airflow passes through the airflow tubes 126, the airflow tubes 126 provides sufficient cooling such that the lower temperature compressed airflow may drop below its dew point. As the lower temperature compressed airflow drops below its dew point, the moisture in the compressed air condenses into liquid particles and droplets, resulting in a dehumidified airflow. The momentum of the compressed airflow through the airflow tubes 126 carries the liquid particles and droplets to the outlet housing 122 of the CAC 108. As droplets of condensate collides and coalesces with other droplets, the liquid condensate drops out and settles in the outlet housing 122.

The liquid condensate settles in the lower portion of the outlet housing 122, in which the first end 146 of the wicking material 144 is disposed. The liquid condensate comes in contact with the first end 146 of wicking material 144 and, by way of capillary action, the wicking material 144 draws the liquid condensate through the elongated body 150 of the wicking material 144. Depending on the amount of condensate formed in the outlet housing 122, the condensate is drawn from the first end 146 of the wicking material 144 through the elongated body 150 of the wicking material 144 to the second end 148 of the wicking material 144.

As the dehumidified airflow exits the outlet port 124 of the outlet housing 122 and flowing through the outlet duct 114 to engine manifold 116, the dehumidified air flow comes in contact with the elongated body 150 and second end 148 of the wicking material 144. The lower humidity airflow causes the moisture in the wicking material 144 to evaporate into the combustion airflow and into the combustion chamber. The overall length of the wicking material 144 extending into the outlet duct 114 toward the engine may be adjusted accordingly to metered predetermined amounts of condensate evaporating into the airflow to the engine during periods of high power output demand.

It should be appreciated that the wicking material 144, in essences, controls the rate of condensate removal from the outlet housing 122 by evaporating the condensate back into the combustion airflow in a metered fashion. Without the wicking material 144 metering the rate of condensate removal from the outlet housing 122, the amount of condensate accumulated in the outlet housing 122 may cause droplets or slugs of condensate to splash out of the outlet housing 122 into the airflow towards the engine. The momentum of the airflow would carry the droplets or slugs of condensate to the combustion chamber, thereby causing combustion issues resulting in poor engine performance and the engine management controller generating error codes.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A heat exchanger having a condensate dispersion device, comprising:
an outlet housing having an interior surface defining an outlet airflow chamber, and an outlet port in fluid communication with the outlet airflow chamber;
an outlet duct in fluid having an interior surface defining an outlet duct airflow passageway in fluid communication with the outlet port; and
a wicking material having a first end and a second end opposite the first end, wherein the first end is disposed in the outlet airflow chamber and the second end is disposed in the outlet duct airflow passageway.

2. The heat exchanger of claim 1, wherein the interior surface of the outlet housing further defines a condensate receiver located at a lower portion of the outlet airflow chamber, and wherein the first end of the wicking material is disposed within the condensate receiver.

3. The heat exchanger of claim 2, wherein the wicking material includes an elongated body extending from the first end through the outlet port to the second end.

4. The heat exchanger of claim 3, further comprising an airflow tube having an airflow tube outlet end in fluid communication with the outlet airflow chamber, wherein a first portion of the elongated body of the wicking material is spaced from the airflow tube outlet end and abuts against a portion of the interior surface of the outlet housing such that the wicking material does not substantially obstruct an airflow through the outlet airflow chamber.

5. The heat exchanger of claim 4, wherein a second portion of the elongated body of the wicking material is abutted against a portion of the interior surface of the outlet duct such that the wicking material does not substantially obstruct the airflow through the outlet duct airflow passageway.

6. The heat exchanger of claim 5, further comprising a plurality of fasteners fixing the first and second portions of the elongated body of the wicking material against the portion of the interior surface of the outlet housing and against the portion of the interior surface of the outlet duct, respectively.

7. The heat exchanger of claim 5, wherein the wicking material comprises a rectangular cross-section.

8. The heat exchanger of claim 5, wherein the wicking material comprises a material configured to draw in condensate and releases the drawn in condensate into a stream of airflow by evaporation.

9. The heat exchanger of claim 8, wherein the first end of the wicking material includes a first cross-sectional area and the elongated body includes a second cross-sectional area, wherein the first cross-sectional area is greater than the second cross sectional area.

10. A charge air cooler having a condensate dispersion device, comprising:
an inlet housing having an inlet port configured to receive a heated pressurized airflow containing a water vapor;
an outlet housing having an outlet port and an interior surface defining a condensate receiver located at a lower portion of the outlet housing;
a plurality of airflow tubes connecting the inlet housing to the outlet housing such that the inlet housing is in fluid communication with the outlet housing, wherein the plurality of airflow tubes are configured transfer heat from the heated pressurized airflow to an ambient airflow; and
a wicking material partially disposed in the condensate receiver and extending through the outlet port of the outlet housing.

11. The charge air cooler of claim 10, further comprising an outlet duct having an inlet end engaged to the outlet port of the outlet housing and an outlet end opposite of the inlet end;
wherein the wicking material comprises a first end, a second end opposite the first end, and an elongated body extending from the first end to the second end, and
wherein the first end of the wicking material is disposed within the condensate receiver, the second end of the wicking material is disposed within the outlet duct, and the elongated body extends from the outlet housing into the outlet duct through the outlet port.

12. The charge air cooler of claim 11, wherein the elongated body of the wicking material is abutted against a portion of the interior surface of the outlet housing and against a portion of an interior surface of the outlet duct such that the wicking material does not substantially obstruct the airflow through the outlet housing and outlet duct.

13. The charge air cooler of claim 12, further comprising a plurality of fasteners fixing the elongated body of the wicking material against the respective portions of the interior surfaces of the outlet housing and of the outlet duct.

14. The charge air cooler of claim 10, wherein the wicking material comprises a rectangular cross-section.

15. The charge air cooler of claim 10, wherein the wicking material comprises a material configured to draw in condensate from the condensate receiver and evaporate the drawn in condensate into a stream of airflow through the outlet duct.

16. The charge air cooler of claim 10, wherein the wicking material comprises braided strand material.

17. A method of dispersing condensate from a charge air cooler, comprising the steps of:
cooling an airflow containing moisture below a dew point of the airflow such that a portion of the moisture condenses into a plurality of droplets of liquid;
passing the airflow through an outlet housing of the charge air cooler such that a portion of the plurality of droplets coalesces into a condensate and settles into a lower portion of the outlet housing;
wetting a wicking material by contacting a first portion of the wicking material with the settled condensate such that the condensate wets a second portion of the wicking material extending from the first portion; and
exposing the second portion of the wicking material to the airflow such that the condensate wetting the second portion evaporates into the airflow.

18. The method of claim 17, further comprising the step of:
fixing the second portion of the wicking material against an internal surface of the outlet housing such that the second portion of the wicking material does not substantially obstruct the airflow through the outlet housing.

19. The method of claim 18, further comprising the step of:
extending the second portion of the wicking material through an outlet port of the outlet housing into an outlet duct.

20. The method of claim 19, further comprising the step of:
collecting the condensate in a condensate receiver located at a lower portion of the outlet housing; and
disposing the first portion of the wicking material in the condensate receiver such that the first portion of the wicking material is contact with the condensate.
